(19) United States
(12) Patent Application Publication
(10) Pub. No.: US 2021/0357202 A1
(43) Pub. Date: Nov. 18, 2021

(54) FIRMWARE UPDATING

(71) Applicant: Intel Corporation, Santa Clara, CA (US)

(72) Inventors: Piotr SWIRYDCZUK, Gdansk (PL); Sagar V. DALVI, Hillsboro, OR (US)

(21) Appl. No.: 17/389,158

(22) Filed: Jul. 29, 2021

(51) Int. Cl. G06F 8/65; G06F 21/57; G06F 9/445

(52) U.S. Cl. CPC G06F 8/65; G06F 9/44589; G06F 21/572

(57) ABSTRACT

Examples described herein include a device, that when operational, is to: during an update of firmware for the device, execute a reduced function firmware to maintain operation of the device, wherein the reduced function firmware provides the device with less functionality than the updated firmware. In some examples, the reduced function firmware comprises a verified reduced function firmware. In some examples, the reduced function firmware comprises an updated version of a reduced function firmware that overwrites a full firmware in firmware storage.

### BACKGROUND

Computing devices utilize firmware for hardware initialization, low-level hardware management, and managing a boot process. In addition to the platform firmware, computing devices may also include dedicated firmware for controller chips, peripheral devices, or other components. Firmware is typically read at runtime and in connection with a boot, but may be updated in connection with a specialized firmware update process.

Run-time firmware patches can be deployed for various central processing unit (CPU) firmware engines to fix bugs (errors), introduce newer capabilities, or revert to a prior firmware version. Some firmware patches require system reset. However, rebooting a CPU can lead to system downtime in which the CPU is not able to execute workloads or latency of workload completion increases. CPU downtime can increase total cost of ownership (TCO) of a data center owner or operator, which can be undesirable.

### BRIEF DESCRIPTION OF THE DRAWINGS

FIG. 1 depicts an example system.

FIG. 2 depicts an example system.

FIGS. 3A and 3B depict example operations.

FIGS. 4A and 4B depict example processes.

FIG. 5 depicts an example process.

FIG. 6 depicts an example system.

### DETAILED DESCRIPTION

Some examples provide a manner of updating firmware of a device while allowing the device to continue operation and without causing the device to shut down. During a firmware update, two versions of firmware can be updated: a first version can be a reduced function set firmware and a second version can be a full function set firmware. Authenticity of a firmware update can be verified prior to execution of the firmware. When a firmware update occurs for the device, execution of the first version of the firmware can allow the operating system (OS) to continue to execute. However, some features of the device might not be available until the second version of the firmware is executed. After the second version of the firmware is updated, and verified, the device can execute the second version of the firmware. In case of a firmware update error or power failure during update of the first or second versions of firmware, the device could fall back to a reduced image or the first version of the recovery image and continue to operate. Accordingly, avoiding reset during a firmware update can allow continued OS execution and workload execution during a firmware update. For example, the firmware can include Microsoft Windows® server platform services (SPS). In some examples, in case of a power loss during or after a firmware update or an error during a firmware update, a device can have a version of a firmware to execute.

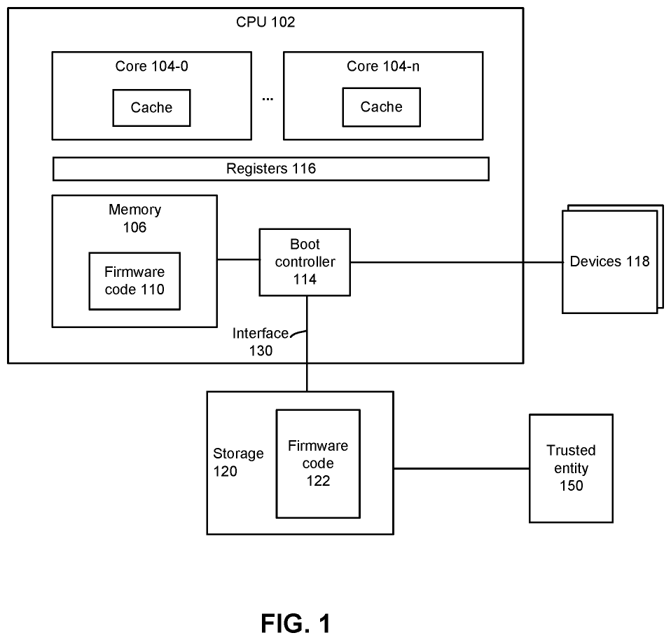

FIG. 1 depicts an example system. Central processing unit (CPU) 102 can include cores 104-0 to 104-n. A core can be an execution core or computational engine that is capable of executing instructions. A core can have access to its own cache and read only memory (ROM), or multiple cores can share a cache or ROM. Cores can be homogeneous and/or heterogeneous devices. Any type of inter-processor communication techniques can be used, such as but not limited to messaging, inter-processor interrupts (IPI), inter-processor communications, and so forth. Cores can be connected in any type of manner, such as but not limited to, bus, ring, or mesh. A core may support one or more instructions sets (e.g., the x86 instruction set (with some extensions that have been added with newer versions); the MIPS instruction set of MIPS Technologies of Sunnyvale, Calif.; the Advanced RISC Machines (ARM) instruction set (with optional additional extensions such as NEON) of ARM Holdings of Sunnyvale, Calif.), including the instruction(s) described herein. In addition or alternative to use of a CPU, an XPU or xPU could be used. An XPU can include one or more of: a graphics processing unit (GPU), general purpose GPU (GPGPU), field programmable gate arrays (FPGA), Accelerated Processing Unit (APU), accelerator or another processor.

One or more of cores 140-0 to 104-n can execute an operating system (OS). In some examples, the OS can be Linux®, Windows® Server or personal computer, Android®, MacOS®, iOS®, VMware vSphere, or any other operating system. The OS and driver can execute on a CPU or processor sold or designed by Intel®, ARM®, AMD®, Qualcomm®, IBM®, Texas Instruments®, among others.

CPU 102 can cause boot controller 114 to access firmware code 122 from storage 120 and copy the firmware code to memory 106 (shown as firmware code 110) for execution by one or more cores. Boot firmware code or firmware can have a header file that identifies a map of what boot code is to be copied by CPU 102. For example, a .h file for a firmware code can have a flash image layout map of which segments of the firmware code are to be copied. When executed by a processor, firmware code can be executed by a processor to perform hardware initialization during a booting process (e.g., power-on startup or restart), and provide runtime services for operating systems and programs.

In some examples, boot controller 114 can access firmware code 122 from storage 120 and copy the firmware code to a memory device for execution by one or more of devices 118. In some examples, storage 120 can be connected to boot controller 114 using a fabric or network and a firmware update can be transmitted using one or more packets via a fabric or network interface (not shown). One or more devices 118 can include one or more of: an XPU, infrastructure processing unit (IPU), CPU, CPU socket, graphics processing unit (GPU), processor, accelerator device, Board Management Controller (BMC), storage controller, memory controller, display engine, a peripheral device, Intel® Management or Manageability Engine (ME), AMD Platform Security Processor (PSP), ARM core with TrustZone extension, network interface device, Platform Controller Hub (PCH), application specific integrated circuit (ASIC), and so forth.

For example, an ME can include one or more processors and allow for powering on, configuring, controlling, or resetting a computer system via communications received using a network interface device. For example, an ME can provide for fan speed control and monitoring of temperature, voltage, current and fan speed sensors. For example, an ME can provide secure audio and/or video communication path. For example, an ME can provide a secure boot process by requiring firmware to be verified by its digital signature prior to boot. A PCH can include a chipset or circuit board that provides data paths and a display interface, input/output controller, clock, and other circuitry.

In some examples, boot firmware code or firmware can include one or more of: Basic Input/Output System (BIOS), video BIOS (VBIOS), GPU BIOS, Universal Extensible Firmware Interface (UEFI), or a boot loader. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

Trusted entity 150 can include a BIOS, BMC or other hardware that can send commands to update firmware, verify firmware and/or cause execution of a particular reduced or full firmware. For example, trusted entity 150 can transmit Intelligent Platform Management Interface (IPMI)-consistent commands to an ME or other device to update firmware, verify firmware and/or cause execution of a particular reduced or full firmware.

Boot controller 114 can be any type of controller (e.g., microcontroller) or processor capable of managing firmware code loading and storage into memory 106 or other memory. In some examples, boot controller 114 can be implemented using a CPU core (e.g., any of 104-0 to 104-n) or a thread of a multi-threaded core. In some examples, boot controller 114 can be coupled to storage 120 using interface 130. Interface 130 can provide communication using one or more of the following protocols: serial peripheral interface (SPI), enhanced SPI (eSPI), System Management Bus (SMBus), I2C, MIPII3C®, Peripheral Component Interconnect Express (PCIe), Compute Express Link (CXL). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

As described herein, device 118 can execute a firmware code 122 at least from a first or second slot in storage 120. A bootable and verified copy of a firmware can be stored in at least one or a first or second slot in storage 120. Executable firmware types can include firmware version (a) for running essential services for server systems operation and restraining from accessing PCH SPI after booting (e.g., a reduced firmware) and firmware version (b) executable for essential and extended services for server systems operation and management (e.g., full firmware). For example, power limiting may not be supported by reduced firmware compared to the full firmware supporting power limiting. For example, reduced device power management features may be supported by reduced firmware compared to the full firmware supporting device power management features. For example, reduced or no power monitoring features may be supported by reduced firmware compared to the full firmware supporting full power monitoring features. For example, reduced or no platform telemetry collection and reporting may be supported by reduced firmware compared to the full firmware supporting full platform telemetry collection and reporting features. For example, reduced or no input from one or more sensors may be supported by reduced firmware compared to the full firmware supporting input from one or more sensors.

An error message can be issued to the OS, if a feature is requested but not supported by the reduced firmware, and the device whose firmware is being updated can continue to run. In some examples, a device firmware can be updated while the system is running an OS when the device is running version (a) firmware to sustain system operability. In some examples, some of the SPS functionality can be limited in reduced firmware compared to full firmware.

For example, a firmware update operation can include: the device whose firmware is to be updated executing a first reduced firmware version; storing a second reduced firmware into one of the slots such as a slot that formerly stored a full firmware version; after verification of the second reduced firmware version, the device whose firmware is to be updated executing the second reduced firmware version; storing a full firmware version into another slot such as the slot that stored the first reduced firmware; and after verification of the full firmware version, the device whose firmware is to be updated executing the full firmware version.

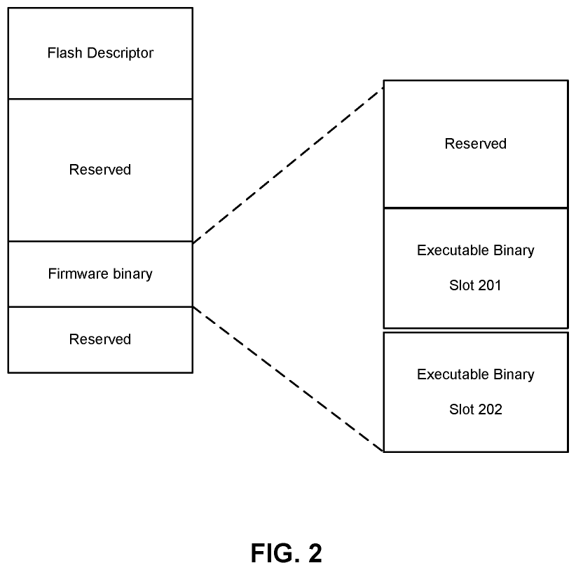

FIG. 2 depicts an example manner of storing firmware. For example, the layout can be used to store firmware accessible by a device. A slot can be a range of addressable storage regions. For example, slot 201 and slot 202 can be addressable storage regions. In some examples, as described herein, slot 201 and slot 202 can store updated reduced firmware prior to one of slot 201 or slot 202 storing a full firmware. Note that more than two slots can be used to store reduced or full firmware, despite two slots being shown. In some examples, an ordering of updating and execution of firmware can include: overwriting full firmware with a second reduced firmware and retaining a reduced firmware to which to fall back to; after verification of the second reduced firmware, executing the second reduced firmware while overwriting the reduced firmware with a second full firmware; and executing the second full firmware.

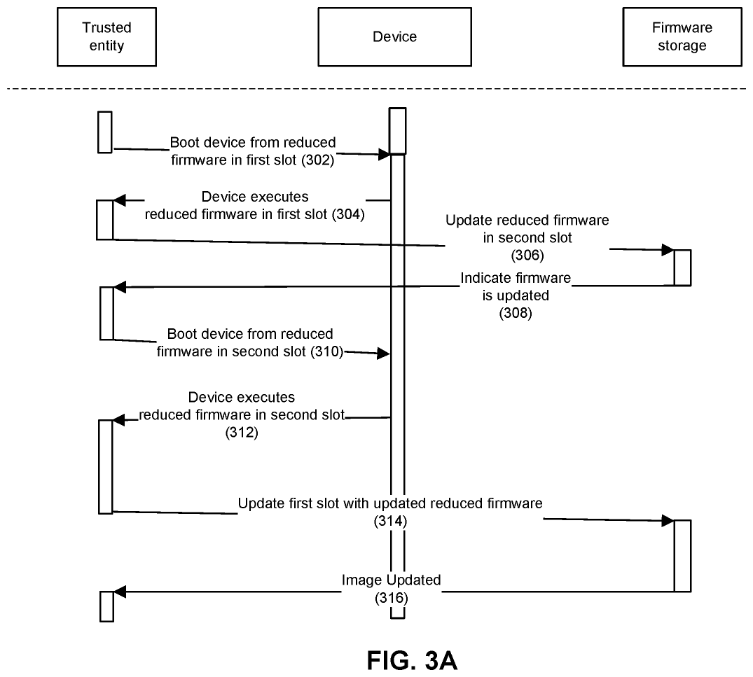

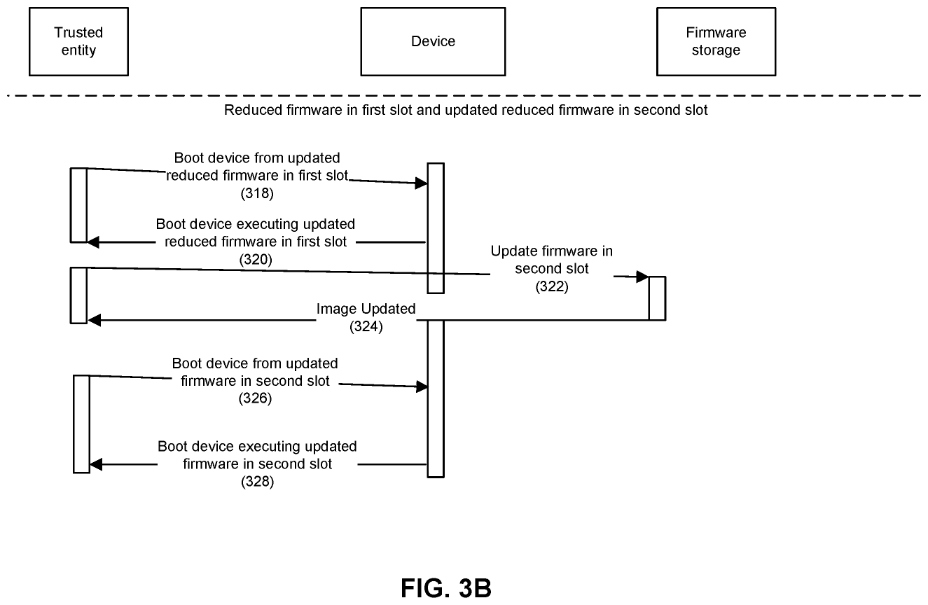

FIGS. 3A and 3B depict an example flow of operation. Updating firmware can include three stages of firmware updates: recovery on operational firmware updates stage, recovery firmware updates stage, and operational firmware updates stage. One or more firmware updates can be verified, but, if a firmware update is not verified, the device can boot from a verified firmware image.

Updating of a firmware can include updating at least two versions of the firmware, namely a first version that is a reduced function firmware (reduced firmware) and a second version that is a full functioning firmware (firmware or full firmware). In some examples, prior to a firmware update, a first slot can store a reduced firmware and a second slot can store a full firmware. At 302, a trusted entity can send a command to a device whose firmware is to be updated to execute a reduced firmware image in a first slot. The device can execute the reduced firmware in the first slot. At 304, the device can indicate to the trusted entity that the device is executing the reduced firmware.

At 306, the trusted entity can write a second reduced firmware into the second slot of the firmware storage, which formerly stored the full firmware. At 308, a firmware storage controller can indicate that the second slot stores the second reduced firmware to the trusted entity. At 310, the trusted entity can command the device to boot the second reduced firmware from the second slot. In case of failure of the device to boot the reduced firmware from the second slot, the device can boot using the reduced firmware in the first slot.

At 312, the device can provide a status to the trusted entity that the device booted the second reduced firmware from the second slot. The status can indicate a firmware version that is being executed. The trusted entity can check if the updated second reduced firmware has been correctly activated by verifying that a firmware version matches an updated recovery version. If there is failure of verification, then the trusted entity can cause the device to execute a previously verified firmware version such as the reduced firmware in the first slot and/or indicate to an administrator that the full firmware version for a particular device is not verified.

At 314, the trusted entity can update the first slot with a third reduced firmware. At 316, the firmware storage controller can indicate to the trusted entity that the first slot stores the third reduced firmware. At 318, the trusted entity can command the device to run the third reduced firmware image in the first slot. The device can execute the third reduced firmware in the first slot. In some examples, the trusted entity can activate execution of the third reduced firmware in the first slot by sending a command to force recovery. In case of failure to boot the third reduced firmware from the first slot, second reduced firmware in the second slot can be executed. At 320, the device can indicate to the trusted entity that the device is executing the third reduced firmware. For example, the trusted entity can send a Get FW status command and the device responds with FW status with a FW version. The trusted entity can check if the third reduced firmware in the first slot has been correctly activated by verifying FW version matches new recovery version and recovery reason is set to enforced by command.

At 322, the trusted entity can update the second slot with a second full firmware. At 324, the firmware storage controller can indicate to the trusted entity that the second slot stores the second full firmware. At 326, the trusted entity can activate the second full firmware for execution from the second slot by sending a Force ME Recovery command. In case of failure of the device to boot the full firmware from the second slot, the device can boot using the reduced firmware from the second slot. At 328, the device can indicate to the trusted entity that the device is executing the updated full firmware. The trusted entity can check if the updated reduced firmware has been correctly activated by verifying that a firmware version matches an updated recovery version. If there is failure of verification, then the trusted entity can cause the device to execute a previously verified firmware version (including reduced firmware version) and/or indicate to an administrator that the full firmware version for a particular device is not verified.

In some examples, 314 to 320 are not performed and the device can continue to execute the second reduced firmware and not a third reduced firmware, the second full firmware can be written to the first slot instead of the second slot, and the device can execute the second full firmware from the first slot.

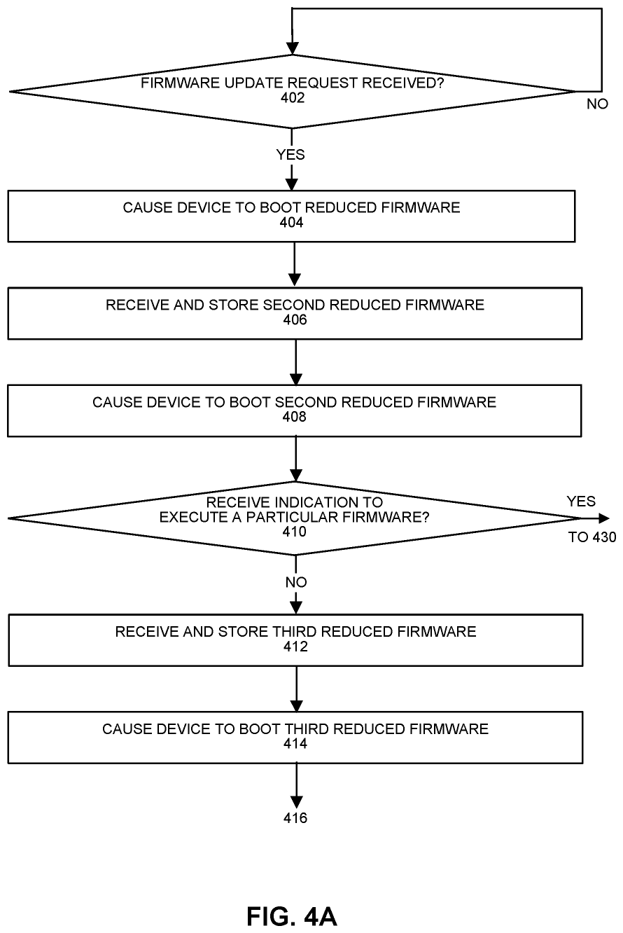

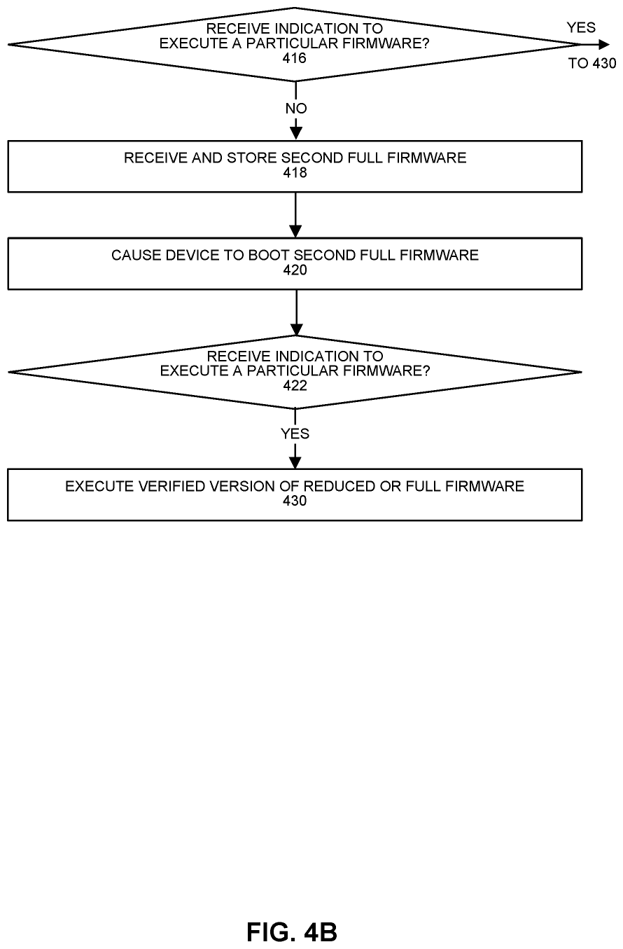

FIGS. 4A and 4B depict an example process that can be executed by a boot controller. At 402, a determination can be made if a firmware update is requested. If a firmware update is requested, the process can proceed to 404. If a firmware update is not requested, the process can repeat 402.

At 404, the device can boot from reduced firmware from a first slot of a firmware storage. A slot of a firmware storage can store a reduced or full firmware. At 406, a second reduced firmware can be received. The second reduced firmware can be stored in a second slot of a firmware storage. At 408, in response to a request to boot second reduced firmware from a second slot, the device can boot second reduced firmware from the second slot and indicate a firmware version to a trusted entity. In some cases, the second reduced firmware is a same firmware as the reduced firmware in the first slot. In some cases, the second reduced firmware is a different firmware as the reduced firmware in the first slot.

At 410, the boot controller can determine if an indication is received to execute a particular firmware after an update of a reduced firmware. For example, the device can receive an indication to execute the reduced firmware from the first slot based on the second reduced firmware in second slot being identified as not verified by the trusted entity. If the device receives an indication to execute a particular firmware after an update of a reduced firmware, then the process can continue to 430. If the device does not receive an indication to execute a particular firmware after an update of a reduced firmware, then the process can continue to 412.

At 412, a third reduced firmware can be received. The third reduced firmware can be stored in the first slot. At 414, in response to a request to boot third reduced firmware from the first slot, the device can boot third reduced firmware from the first slot and indicate a firmware version to a trusted entity.

Referring to FIG. 4B, at 416, the boot controller can determine if an indication is received to execute a particular firmware after an update of a reduced firmware. For example, the device can receive an indication to execute the second reduced firmware from a second slot based on the third reduced firmware in the first slot being identified as not verified by the trusted entity. If the device receives an indication to execute a particular firmware after an update of a reduced firmware, then the process can continue to 430. If the device does not receive an indication to execute a particular firmware after an update of a reduced firmware, then the process can continue to 418.

At 418, a second full firmware can be received. The second full firmware can be stored in the second slot, or another slot. At 420, in response to a request to boot the second full firmware, the device can boot the second full firmware from the second slot and indicate a firmware version to a trusted entity.

At 422, the boot controller can determine if an indication is received to execute a particular firmware after an update of a firmware. For example, the device can receive an indication to execute the third reduced firmware from the first slot based on the firmware in the second slot being identified as not verified by the trusted entity. If the device receives an indication to execute a particular firmware after an update of a firmware, then the process can continue to 430. If the device does not receive an indication to execute a particular firmware after an update of a firmware, then the process can end or continue to another operation.

At 430, the boot controller can execute a verified reduced or full firmware that is stored in a slot that was not most recently updated. For example, after storage of the second reduced firmware, the verified reduced firmware can be executed. For example, after storage of the third reduced firmware, the verified second reduced firmware can be executed. For example, after storage of the full firmware, the verified third reduced firmware can be executed.

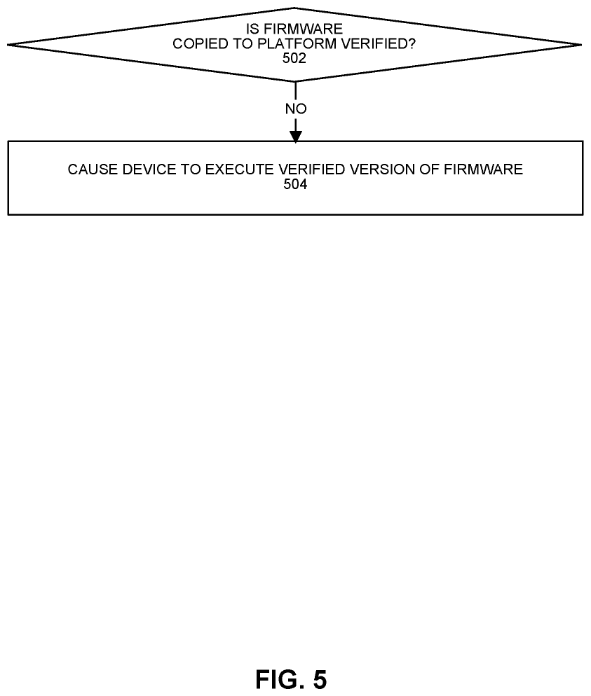

FIG. 5 depicts an example process that can be executed by a trusted entity. At 502, a trusted entity can verify a firmware recently copied to a firmware storage of a device. Verification can be based at least on a firmware version in some examples. If the firmware is verified, then the process can end. If the firmware is not verified, then the process can continue to 504, where the trusted entity can cause the device to execute a prior verified reduced or full firmware and inform an administrator of the particular firmware update that is unverified.

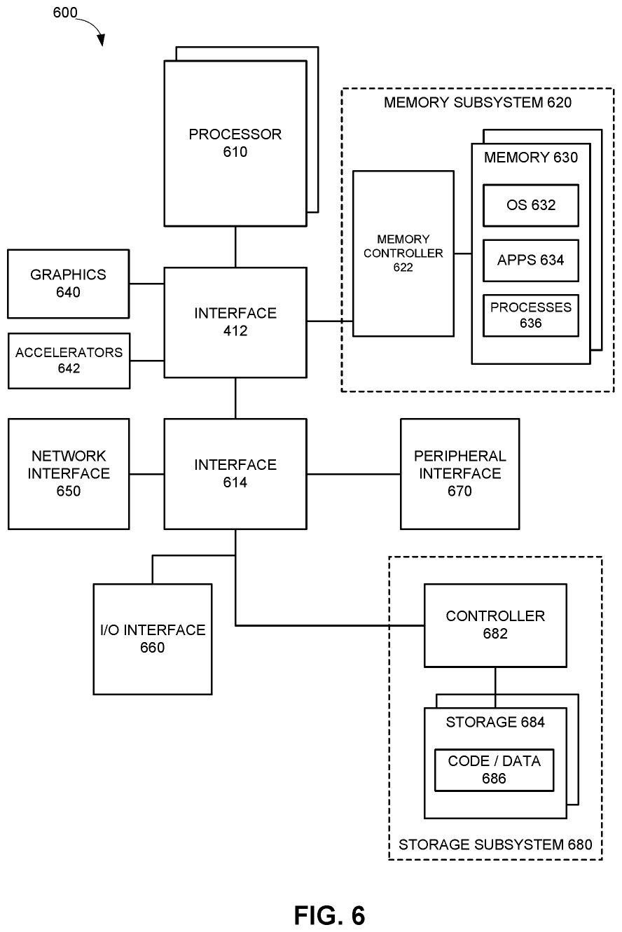

FIG. 6 depicts a system. Various examples can be used by system 600 to update or access an updated firmware as described herein. System 600 includes processor 610, which provides processing, operation management, and execution of instructions for system 600. Processor 610 can include any type of microprocessor, central processing unit (CPU), graphics processing unit (GPU), Accelerated Processing Unit (APU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1180p), retina displays, 6K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide sequential and speculative decoding operations in a manner described herein, compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs).

Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models. A firmware update of a processor 610 or an accelerator 642 can occur using technologies described herein.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 650 can receive data from a remote device, which can include storing received data into memory. Various examples can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 1046 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory can involve refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In some examples, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniB and, Internet Wide Area RDMA Protocol (iWARP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples can be used in a base station that supports communications using wired or wireless protocols (e.g., 3GPP Long Term Evolution (LTE) (4G) or 3GPP 5G), on-premises data centers, off-premises data centers, edge network elements, edge servers and switches, fog network elements, and/or hybrid data centers (e.g., data center that use virtualization, cloud and software-defined networking to deliver application workloads across physical data centers and distributed multi-cloud environments).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in examples.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An example of the devices, systems, and methods may include any one or more, and any combination of, the examples described below.

Example 1 includes one or more examples and includes a method comprising: maintaining operation of a device during an update of firmware to a storage device by: executing a reduced function firmware during the update of firmware to the storage device and booting the firmware from the storage device after the update of the firmware to the storage device.

Example 2 includes one or more examples and includes storing multiple copies of a reduced function firmware prior to updating the firmware of the device.

Example 3 includes one or more examples, wherein the executed reduced function firmware comprises a verified reduced function firmware.

Example 4 includes one or more examples, wherein the booting the firmware from the storage device after the update of the firmware to the storage device is based on the reduced function firmware having been verified.

Example 5 includes one or more examples, and includes copying the reduced function firmware to a first region of a firmware storage; copying a second reduced function firmware to a second region of the firmware storage; and overwriting the first region of the firmware storage with the firmware.

Example 6 includes one or more examples, wherein: overwriting the first region of the firmware storage with the firmware is based at least on verification of the second reduced function firmware.

Example 7 includes one or more examples, wherein the reduced function firmware provides one or more of: reduced measurement of outputs from one or more sensors, reduced device power management features, limited power monitoring features and/or reduced platform telemetry collection and reporting.

Example 8 includes one or more examples, wherein a boot controller performs the executing a reduced function firmware during the update of firmware to the storage device and booting the firmware from the storage device after the update of the firmware to the storage device.

Example 9 includes one or more examples, and includes an apparatus comprising: a device, that when operational, is to: during an update of firmware for the device, execute a reduced function firmware to maintain operation of the device, wherein the reduced function firmware provides the device with less functionality than the updated firmware.

Example 10 includes one or more examples, wherein the reduced function firmware comprises a verified reduced function firmware.

Example 11 includes one or more examples, wherein the reduced function firmware comprises an updated version of a reduced function firmware that overwrites a full firmware in firmware storage.

Example 12 includes one or more examples, wherein the reduced function firmware provides one or more of: reduced measurement of outputs from one or more sensors, reduced device power management features, limited power monitoring features and/or reduced platform telemetry collection and reporting.

Example 13 includes one or more examples, wherein the firmware is to provide operations of the reduced function firmware and one or more of: measurement of outputs from one or more sensors, device power management features, power monitoring features and/or platform telemetry collection and reporting.

Example 14 includes one or more examples, wherein the device comprises one or more of: an XPU, infrastructure processing unit (IPU), central processing unit (CPU), CPU socket, graphics processing unit (GPU), processor, accelerator device, Board Management Controller (BMC), storage controller, memory controller, display engine, a peripheral device, Intel® Management or Manageability Engine (ME), AMD Platform Security Processor (PSP), Advanced RISC Machines (ARM) core with TrustZone extension, network interface device, Platform Controller Hub (PCH), or application specific integrated circuit (ASIC).

Example 15 includes one or more examples, and includes server that includes the device, wherein: prior to the firmware update, the server is to command the device to perform one or more operations and wherein the maintain operation of the device comprises perform the one or more operations.

Example 16 includes one or more examples, and includes a computer-readable medium comprising instructions stored thereon, that if executed by one or more processors, cause the one or more processors to: during an update of firmware for a device, execute a reduced function firmware to maintain operation of the device, wherein the reduced function firmware provides the device with less functionality than the updated firmware.

Example 17 includes one or more examples, wherein the reduced function firmware comprises a verified reduced function firmware.

Example 18 includes one or more examples, wherein the reduced function firmware comprises an updated version of a reduced function firmware that overwrites a full firmware in firmware storage.

Example 19 includes one or more examples, wherein the reduced function firmware provides one or more of: reduced measurement of outputs from one or more sensors, reduced device power management features, limited power monitoring features and/or reduced platform telemetry collection and reporting.

Example 20 includes one or more examples, wherein the device comprises one or more of: an XPU, infrastructure processing unit (IPU), central processing unit (CPU), CPU socket, graphics processing unit (GPU), processor, accelerator device, Board Management Controller (BMC), storage controller, memory controller, display engine, a peripheral device, Intel® Management or Manageability Engine (ME), AMD Platform Security Processor (PSP), Advanced RISC Machines (ARM) core with TrustZone extension, network interface device, Platform Controller Hub (PCH), or application specific integrated circuit (ASIC).

What is claimed is:

1. A method comprising:
maintaining operation of a device during an update of firmware to a storage device by:
executing a reduced function firmware during the update of firmware to the storage device and
booting the firmware from the storage device after the update of the firmware to the storage device.

2. The method of claim 1, comprising:
storing multiple copies of a reduced function firmware prior to updating the firmware of the device.

3. The method of claim 1, wherein the executed reduced function firmware comprises a verified reduced function firmware.

4. The method of claim 1, wherein the booting the firmware from the storage device after the update of the firmware to the storage device is based on the reduced function firmware having been verified.

5. The method of claim 1, comprising:
copying the reduced function firmware to a first region of a firmware storage;
copying a second reduced function firmware to a second region of the firmware storage; and
overwriting the first region of the firmware storage with the firmware.

6. The method of claim 5, wherein:
overwriting the first region of the firmware storage with the firmware is based at least on verification of the second reduced function firmware.

7. The method of claim 1, wherein the reduced function firmware provides one or more of: reduced measurement of outputs from one or more sensors, reduced device power management features, limited power monitoring features and/or reduced platform telemetry collection and reporting.

8. The method of claim 1, wherein a boot controller performs the executing a reduced function firmware during the update of firmware to the storage device and booting the firmware from the storage device after the update of the firmware to the storage device.

9. An apparatus comprising:
a device, that when operational, is to:
during an update of firmware for the device, execute a reduced function firmware to maintain operation of the device, wherein the reduced function firmware provides the device with less functionality than the updated firmware.

10. The apparatus of claim 9, wherein the reduced function firmware comprises a verified reduced function firmware.

11. The apparatus of claim 9, wherein the reduced function firmware comprises an updated version of a reduced function firmware that overwrites a full firmware in firmware storage.

12. The apparatus of claim 9, wherein the reduced function firmware provides one or more of: reduced measurement of outputs from one or more sensors, reduced device power management features, limited power monitoring features and/or reduced platform telemetry collection and reporting.

13. The apparatus of claim 12, wherein the firmware is to provide operations of the reduced function firmware and one or more of: measurement of outputs from one or more sensors, device power management features, power monitoring features and/or platform telemetry collection and reporting.

14. The apparatus of claim 9, wherein the device comprises one or more of: an XPU, infrastructure processing unit (IPU), central processing unit (CPU), CPU socket, graphics processing unit (GPU), processor, accelerator device, Board Management Controller (BMC), storage controller, memory controller, display engine, a peripheral device, Intel® Management or Manageability Engine (ME), AMD Platform Security Processor (PSP), Advanced RISC Machines (ARM) core with TrustZone extension, network interface device, Platform Controller Hub (PCH), or application specific integrated circuit (ASIC).

15. The apparatus of claim 9, comprising a server that includes the device, wherein:
prior to the firmware update, the server is to command the device to perform one or more operations and wherein the maintain operation of the device comprises perform the one or more operations.

16. A computer-readable medium comprising instructions stored thereon, that if executed by one or more processors, cause the one or more processors to:
during an update of firmware for a device, execute a reduced function firmware to maintain operation of the device, wherein the reduced function firmware provides the device with less functionality than the updated firmware.

17. The computer-readable medium of claim 16, wherein the reduced function firmware comprises a verified reduced function firmware.

18. The computer-readable medium of claim 16, wherein the reduced function firmware comprises an updated version of a reduced function firmware that overwrites a full firmware in firmware storage.

19. The computer-readable medium of claim 16, wherein the reduced function firmware provides one or more of: reduced measurement of outputs from one or more sensors, reduced device power management features, limited power monitoring features and/or reduced platform telemetry collection and reporting.

20. The computer-readable medium of claim 16, wherein the device comprises one or more of: an XPU, infrastructure processing unit (IPU), central processing unit (CPU), CPU socket, graphics processing unit (GPU), processor, accelerator device, Board Management Controller (BMC), storage controller, memory controller, display engine, a peripheral device, Intel® Management or Manageability Engine (ME), AMD Platform Security Processor (PSP), Advanced RISC Machines (ARM) core with TrustZone extension, network interface device, Platform Controller Hub (PCH), or application specific integrated circuit (ASIC).
